(19) United States
(12) Patent Application Publication
(10) Pub. No.: US 2013/0076794 A1
(43) Pub. Date: Mar. 28, 2013

(54) AUTOMATIC ROTATING DISPLAY SYSTEM BASED ON WINDOWS OPERATING SYSTEM

(71) Applicants: CHUN-SHENG CHEN, Tu-Cheng (TW); FENG-LONG HE, Shenzhen City (CN); HUA ZOU, Shenzhen City (CN)

(72) Inventors: CHUN-SHENG CHEN, Tu-Cheng (TW); FENG-LONG HE, Shenzhen City (CN); HUA ZOU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/433,652

(22) Filed: Mar. 29, 2012

(30) Foreign Application Priority Data
Sep. 23, 2011 (CN) 201110285876.1

(51) Int. Cl. G09G 5/00

(52) U.S. Cl. 345/649

(57) ABSTRACT

An automatic rotating display system is adapted to an electronic device based on a windows operating system. The electronic device includes a display for displaying one or more images. The automatic rotating display system includes a gravity sensor, a processor, a keyboard controller and a display card. The gravity sensor is configured for sensing or detecting different positional variations of the electronic device, and generating corresponding different sensing signals, according to the direction and magnitude changes of the electronic device. The processor electrically connects with the gravity sensor for receiving and processing the sensing signals. The keyboard controller connects with the processor for receiving the directional control signals and translating the directional control signals into directional control instructions. The display card connects with the keyboard controller for receiving the directional control instructions and driving the image shown on the display to rotate.

### BACKGROUND

1. Technical Field

The present disclosure generally relates to automatic rotating display systems, and particularly to an automatic rotating display system based on windows operating system.

2. Description of Related Art

Since the source code of the Windows operating system is not available to the public, the resources cannot be shared, thus, it is generally hard to develop some applications based on the Windows operating system. Furthermore, developing an automatic rotating display system based on the Windows system platform then becomes an urgent technical problem to be solved.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure.

FIG. 1 shows a functional module block diagram of an embodiment of an automatic rotating display system based on windows operating system.

FIG. 2 shows a front view of an electronic device using the automatic rotating display system of FIG. 1.

FIG. 3 shows another front view of the electronic device of FIG. 2, in which the electronic device is rotated about 90 degrees along a clockwise direction.

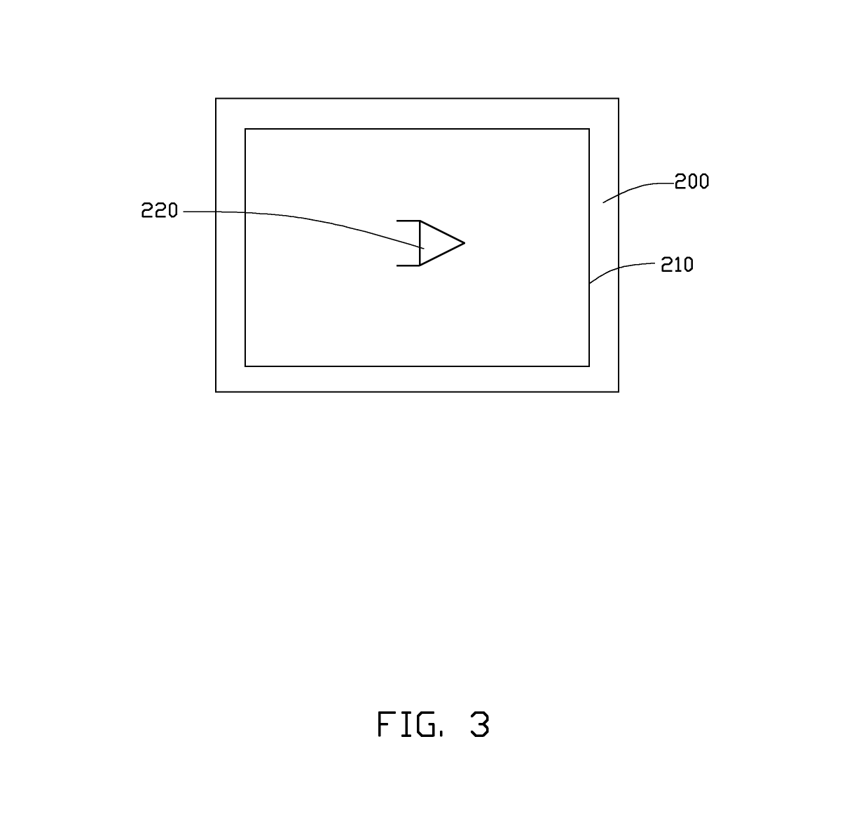

### DETAILED DESCRIPTION

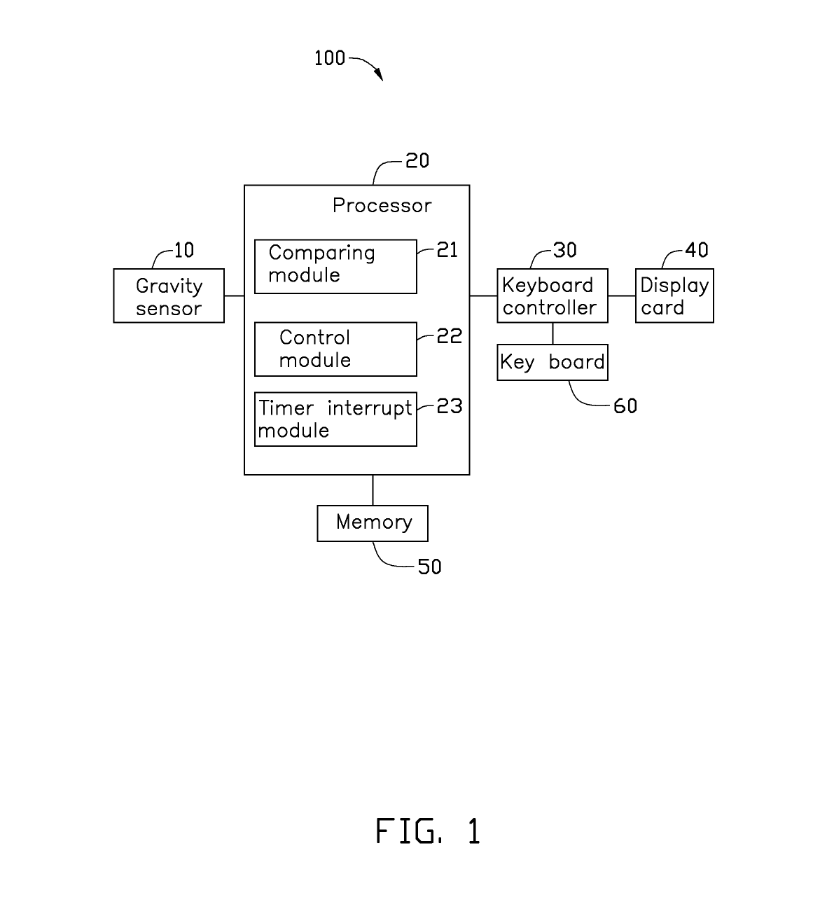

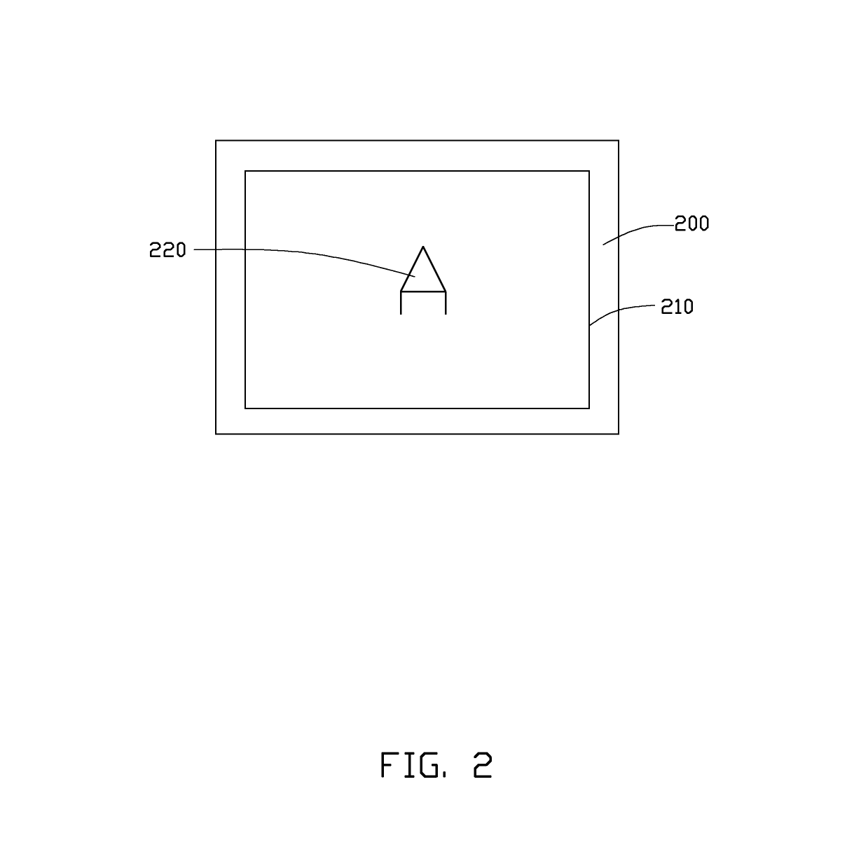

Referring to FIGS. 1 and 2, an embodiment of an automatic rotating display system 100 based on windows operating system is shown. The automatic rotating display system 100 is adapted to an electronic device 200 using the windows operating system, for controlling an image 220 displayed on a display 210 of the electronic device 200 for rotation. The automatic rotating display system 100 includes a gravity sensor (G-sensor) 10, a processor 20, a keyboard controller 30, a display card 40, a memory 50 and a keyboard 60. The gravity sensor 10, the processor 20, the keyboard controller 30 and the display card 40 are electrically connected with each other in that order. The memory 50 is electrically connected with the processor 20, and the keyboard 60 is electrically connected with the keyboard controller 30, respectively.

The gravity sensor 10 is configured for sensing or detecting a plurality of different positional variations of the electronic device 200, and generating corresponding different sensing signals, according to the direction and magnitude changes of the electronic device 200. The sensing signal generated by the gravity sensor 10 is a vector including directional information and size information.

The processor 20 electrically connects with the gravity sensor 10 for receiving and processing the sensing signals generated by the gravity sensor 10, and finally outputting different control signals to the keyboard controller 30. In the illustrated embodiment, the processor 20 includes a comparing module 21, a control module 22 and a timer interrupt module 23. The comparing module 21 and the timer interrupt module 23 are both electronically connected with the control module 22. The comparing module 21 is configured for comparing the size value of the received sensing signal that is sent from the gravity sensor 10 with a preset value stored within the comparing module 21. The control module 22 is configured for selectively sending out different directional control signals according to corresponding different comparative results sent from the comparing module 21. During usage, if the size value of the sensing signal sent from the gravity sensor 10 is greater than the preset value, the control module 22 may then send out corresponding directional control signals to the keyboard controller 30. If the size value of the sensing signal sent from the gravity sensor 10 is less than the preset value, the control module 22 may not send out any control signal. The timer interrupt module 23 is configured for timely interrupting the control signals sent by the control module 22. Namely, the timer interrupt module 23 is used to allow the control module 22 send out control signals at a plurality of intervals within a predetermined time. In the illustrated embodiment, when the gravity sensor 10 senses or detects that the electronic device 200 is tilted rightward, downward, leftward or upwardly, the control module 22 may send out a corresponding first, second, third or fourth control signal to the keyboard controller 30, respectively.

The keyboard controller 30 electrically connects with the control module 22 (of the processor 20), the keyboard 60 and the display card 40. The keyboard controller 30 is configured for receiving the directional control signals sent from the control module 22 and translating the directional control signals into a plurality of directional control instructions. In the illustrated embodiment, the directional control instructions includes a first control instruction, a second control instruction, a third control instruction and a fourth control instruction, corresponding to the first, second, third and fourth directional control instructions, respectively. The directional control instructions can also be inputted via the keyboard 60. The directional control instructions can be manually inputted via the following combination keys of “CTRL+ALT+→, CTRL+ALT+↓, CTRL+ALT+←, CTRL+ALT+↑” to represent the corresponding first, second, third and fourth control signals sent from the processor 20, respectively. The keyboard 60 can be a substantial physical keyboard or a virtual keyboard.

The display card 40 electrically connects with the keyboard controller 30 for receiving the directional control instructions, and driving the image 220 shown on the display 210 of the electronic device 200 to rotate. In the illustrated embodiment, when the display card 40 receives the corresponding first, second, third or fourth control signal output from the keyboard controller 30, the display card 40 then drives the image 220 shown on the display 210 of the electronic device 200 to rotate rightward, downward, leftward or upwardly about 90 degrees.

The memory 50 electrically connects with the processor 20 and is configured for storing the source codes of different software programs run on the processor 20.

Referring to FIG. 2, the image 220 of the display 210 in an original state is shown, in which when the display 210 of the electronic device 200 is titled leftward during usage, the gravity sensor 10 would sense the position variations of the electronic device 200 immediately, and generate a corresponding directional sensing signal sent to the processor 20. The comparing module 21 compares the size value of the sensing signal sent from the gravity sensor 10 with the preset value stored within the comparing module 21. If the size value of the sensing signal sent from the gravity sensor 10 is greater than the preset value, the control module 22 sends out a corresponding first directional control signal to the keyboard controller 30. The keyboard controller 30 receives the first directional control signal and sends it to the display card 40, thereby driving the image 220 shown on the display 210 to rotate rightward about 90 degrees. The image 220 shown on the display 210 can also be rotated downward, leftward, or upwardly according to the different operations to the electronic device 200.

In addition, the image 220 shown on the display 210 can also be controlled to rotate rightward, downward, leftward or upwardly by operating various key combinations of the keyboard 60 even if the electronic device 200 remains motionless.

Finally, while various embodiments have been described and illustrated, the disclosure is not to be construed as being limited thereto. Various modifications can be made to the embodiments by those skilled in the art without departing from the true spirit and scope of the disclosure as defined by the appended claims.

What is claimed is:

1. An automatic rotating display system adapted to an electronic device based on a windows operating system, the electronic device comprising a display for displaying one or more images; the automatic rotating display system comprising:
a gravity sensor configured for sensing or detecting a plurality of different positional variations of the electronic device, and generating corresponding different sensing signals, according to the direction and magnitude changes of the electronic device;
a processor electrically connecting with the gravity sensor for receiving and processing the sensing signals generated by the gravity sensor, and then outputting a plurality of different control signals;
a keyboard controller electrically connecting with the processor for receiving the directional control signals sent from the control module and translating the directional control signals into a plurality of directional control instructions; and
a display card electrically connecting with the keyboard controller for receiving the directional control instructions outputted from the keyboard controller, and driving the image shown on the display of the electronic device to rotate.

2. The automatic rotating display system of claim 1, further comprising a memory electrically connected with the processor, and the memory is configured for storing a plurality of source codes of different software programs run on the processor.

3. The automatic rotating display system of claim 1, wherein further comprising a keyboard electrically connected with the keyboard controller for manually inputting the directional control instructions.

4. The automatic rotating display system of claim 3, wherein the keyboard is a substantial physical keyboard or a virtual keyboard.

5. The automatic rotating display system of claim 1, wherein the sensing signal generated by the gravity sensor is a vector comprising a direction information and a size information.

6. The automatic rotating display system of claim 5, wherein the processor comprises a comparing module and a control module electronically connected with the comparing module; the comparing module is configured for comparing the size value of the received sensing signal sent from the gravity sensor with a preset value stored within the comparing module; the control module is configured for selectively sending out different directional control signals according to corresponding different comparative results sent from the comparing module.

7. The automatic rotating display system of claim 6, wherein the processor further comprises a timer interrupt module electrically connecting with the control module, the timer interrupt module is configured for timely interrupting the control signals sent by the control module thereby allowing the control module to send out control signals at a plurality of intervals within a predetermined time.

8. The automatic rotating display system of claim 6, wherein when the size value of the sensing signal sent from the gravity sensor is greater than the preset value, the control module sends out corresponding directional control signals to the keyboard controller;
when the size value of the sensing signal sent from the gravity sensor is less than the preset value, the control module stops sending out control signal.

9. The automatic rotating display system of claim 3, wherein the control signals comprises a first control signal, a second control signal, a third control signal and a fourth control signal, the directional control instructions are manually inputted via the following combination keys of “CTRL+ALT+→, CTRL+ALT+↓, CTRL+ALT+←, CTRL+ALT+↑” to represent the corresponding first, second, third and fourth control signals sent from the processor, respectively.

10. An electronic device applying a windows operating system, comprising:
a display for displaying one or more images; and
an automatic rotating display system adapted to the electronic device for controlling the image shown on the display to rotate, the automatic rotating display system comprising:
a gravity sensor configured for sensing or detecting a plurality of different positional variations of the electronic device, and generating corresponding different sensing signals, according to the direction and magnitude changes of the electronic device;
a processor electrically connecting with the gravity sensor for receiving and processing the sensing signals generated by the gravity sensor, and then outputting a plurality of different control signals;
a keyboard controller electrically connecting with the processor for receiving the directional control signals sent from the control module and translating the directional control signals into a plurality of directional control instructions; and
a display card electrically connecting with the keyboard controller for receiving the directional control instructions outputted from the keyboard controller, and driving the image shown on the display of the electronic device to rotate.

11. The electronic device of claim 10, wherein the automatic rotating display system further comprises a memory electrically connected with the processor, and the memory is configured for storing a plurality of source codes of different software programs run on the processor.

12. The electronic device of claim 11, wherein the automatic rotating display system further comprises a keyboard electrically connected with the keyboard controller for manually inputting the directional control instructions.

13. The electronic device of claim 12, wherein the keyboard is a substantial physical keyboard or a virtual keyboard.

14. The electronic device of claim 10, wherein the sensing signal generated by the gravity sensor is a vector comprising a direction information and a size information.

15. The electronic device of claim 14, wherein the processor comprises a comparing module and a control module electronically connected with the comparing module; the comparing module is configured for comparing the size value of the received sensing signal sent from the gravity sensor with a preset value stored within the comparing module; the control module is configured for selectively sending out different directional control signals according to corresponding different comparative results sent from the comparing module.

16. The electronic device of claim 15, wherein the processor further comprises a timer interrupt module electrically connecting with the control module, the timer interrupt module is configured for timely interrupting the control signals sent by the control module for thereby allowing the control module to send out control signals at a plurality of intervals within a predetermined time.
